(19) United States
(12) Patent Application Publication
(10) Pub. No.: US 2010/0316247 A1
(43) Pub. Date: Dec. 16, 2010

(54) LOUDSPEAKER AND ALARM WITH LUMINOUS ELEMENT

(76) Inventor: Feng Ding, Zhejiang (CN)

Correspondence Address: HAHN LOESER & PARKS, LLP, One GOJO Plaza, Suite 300, AKRON, OH, 44311-1076, US

(21) Appl. No.: 12/679,437

(22) PCT Filed: Mar. 28, 2008
(86) PCT No.: PCT/CN2008/000629

§ 371 Date: Aug. 30, 2010

(30) Foreign Application Priority Data
Sep. 21, 2007 (CN) 200720114977.1

(51) Int. Cl. H04R 1/00

(52) U.S. Cl. 381/397

(57) ABSTRACT

A loudspeaker has an alarm and a luminous element, these being an improvement upon exiting loudspeakers having luminous elements. The luminous element is an illuminating lamp. A radiative cooling fin is mounted near the illuminating lamp. The use of radiator cooling firework permits a larger power light to be selected as the luminous element. This makes the loudspeaker capable of functioning as a substitute light source within an area. Also, the assembly employs an alarm with the loudspeaker. The brighter light emitted by the illuminating lamp on each loudspeaker provides better illumination. The lamp may also flash according to pre-programmed directions for the purpose of indicating a path and thereby helping people to escape from danger. Further, where the external power source fails, the loudspeaker assembly has a built-in emergency power source, ensuring that the loudspeaker and the illuminating lamp can still work normally.

### TECHNICAL FIELDS

The invention relates to a loudspeaker. In particular it relates to a loudspeaker having an alarm and a luminous element.

### BACKGROUND TECHNOLOGY

A conventional loudspeaker typically has only an audio function, which gives enjoyment only to the ear. To augment this single function, loudspeakers with luminous elements are already known in the marketplace.

Such a device is disclosed, for example, in Chinese patent authorization notification number CN790088 Loudspeaker with luminous element. The base or bottom of the loudspeaker sound cone has phase plug, a parabolic reflector, a transparent ring and a fixed mount with at least a circuit board wire of LED held in the phase plug. The circuit board wire goes through the transparent ring and the bracket of parabolic reflector, then goes out from the hole of the wire on T-yoke.

When a light-emitting diodes (LED) is mounted, the light is reflected by the parabolic reflector, whence it radiates outward though the transparent ring, forming a soft light area at the top of loudspeaker. This provides a pleasing aesthetic effect. It is also known to place a luminous element in front of the diaphragm, as the effect to protect the high tweeter, as indicated in Chinese patent authorization notification number CN2744111Y light-emitting electric speakers

Since the luminous element is mounted on loudspeaker mentioned above, the power can not be too high. The main function of the lights in these examples is not primary lighting. For this reason, heretofore loudspeaker, such as installed in restaurants and coffee shops have not realized the potential of the speaker's multi-functions.

### SUMMARY OF THE INVENTION

This present invention is intended to address the foregoing existing technical problems. It is intended to provide a structure that is a combination of a loudspeaker having a lighting function and an alarm with a luminous element. In an aspect of the invention shown and described herein there is a loudspeaker with a luminous element. It includes a magnet circuit structure that includes a T-yoke. It also includes a speaker frame, a speaker cone, a voice coil, and a spider. The luminous element is located between a heat sink and the T-yoke. This luminous element may be an illuminating lamp. The lamp may have a heat radiator, or cooling fin, or heat sink.

In a feature of that aspect of the invention, there may, optionally, be an illuminating lamp, it and the radiation cup (i.e., the reflector) being connected to the T-yoke by the heat sink, when the post is set up on the speaker frame, such that the illuminating lamp and the edge of the reflector are exposed outside of the lens. The heat sink and T-Yoke form the heat radiator. In a further feature of the invention, the light of illuminating lamp can be sent out directly without reflection, the structure being simpler and easier to assemble. In a further feature glass or other transparent elements can be installed in the reflector to improve the visual effect.

As a further improvement of that aspect of the invention, the T-yoke may have a hole or bore in the center; the illuminating lamp and reflector being located in the bore. In this way, there must have reflection on the illuminating lamp. The radiator is attached to a front bracket having an air hole, there also being a rear bracket having an air hole and a heat sink. The front bracket is located above (or forward of) the top of the bore, and the rear bracket is located at the back or bottom of the hole or bore, and the radiator or heat sink or cooling fin is located between the rear bracket and the illuminating lamp. The air flow created by the movement of speaker cone in the loudspeaker may cause hot air to flow out of the bore in the T-yoke. In this way, the power rating of the light and speaker voice coil may be higher, and the working life of the loudspeaker and illuminating lamp may be increased. A fan may also be mounted between the heat sink and operated to exhaust hot air faster if the heat generated by the loudspeaker and illuminating lamp is high.

In another feature, the T-yoke may be designed as a solid piece. The illuminating lamp may be mounted directly to it, and transparent element may also be fixed on it. The T-yoke functions as the heat radiator. This structure may be used for to low power rated loudspeakers and illuminating lamps.

When the speaker frame has a grill, and the illuminating lamp is fixed in the loudspeaker, the transparent element can be the forward reflector. One side of this forward reflector is through the grill, the other side faces toward the illuminating lamp. The reflection by the forward reflector can focus the light of the illuminating lamp where light is wanted. And this forward reflector can be smaller, terminating under a dust cap. The light will then be projected though a transparent dust cap.

Furthermore, in a feature of that aspect of the invention, the invention may also include an emergency power source. By this means, if the external power fails, the emergency power source can operate to ensure that the loudspeaker produces sound and light normally. The invention may also include auxiliary lights, which may be installed in the speaker cone; or installed on the bars of the speaker frame; or installed on the adapter of the spider; or installed on the first radiation (i.e. cooling) fin between the speaker frame and the top plate; or installed on the second radiator fin between the magnet and the T-yoke; or on the metal cap over the T-yoke; or installed in the grill attached to the speaker frame. Alternatively the auxiliary lights may be set around the illuminating lamp. The alternate embodiments may be used to satisfy different requirements of different lighting needs.

The combination of audio and lighting functions of the loudspeaker may cooperate to define an alarm apparatus. The alarm apparatus may include illuminating lamps, the loudspeaker, a sound alarm chip and a programmable controller. The loudspeaker may include the magnet, the T-yoke, the magnetic top plate, the speaker frame, and the speaker cone, voice coil, and spider that are mounted to the top plate of the magnetic circuit members. The sound alarm chip is connected with the voice coil by means of a trigger (or switch) and loudspeaker's amplifier circuit. The luminous element is installed in the illuminating lamp of loudspeaker located in the reflection bowl, and is fixed on the T-yoke. At the same time a heat sink is mounted adjacent to the illuminating lamp.

In contrast to existing technology, the light in the invention, (which may be a high power light emitting diode or halogen lamp or inert gas lamp) can be used as a primary illuminating lamp, the lighting function being combined with the loudspeaker. So when this invention is used in a restaurant or office, the original lights, alarm and speakers can be eliminated alarm and speakers, which will decorate the ceiling in a more compact way, bringing a new and better visual effect.

Also, by using the light emitted in the illuminating lamp on each loudspeaker, better illumination is provided, as well as permitting each illuminating lamp to operate as a strobe light according to pre-programmed instructions, so as to achieve the purpose of indicating a path, such as may thereby aid people rapidly to find an escape route from a dangerous place. Furthermore, in the event that no external power source is available, the loudspeaker and the illuminating lamp can still be ensured to work normally by means of the built-in emergency power source. Thus in an aspect of the invention the apparatus may provide illumination, emergency and alarm guidance functions as whole, which is very practical and worthy of wide scale use.

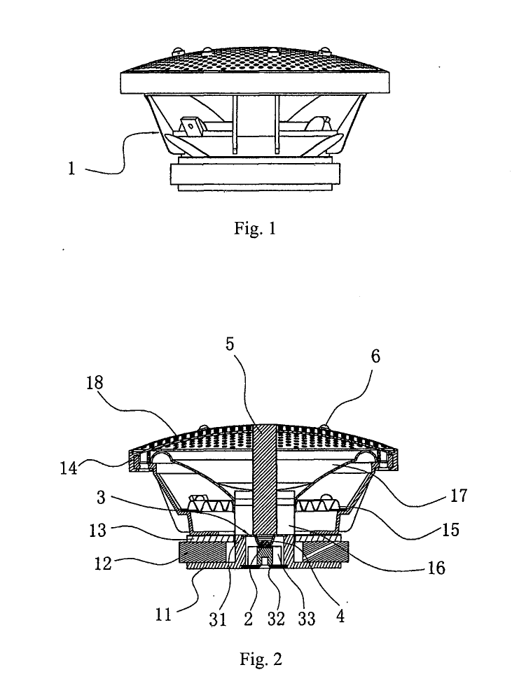

FIG. 1 shows a side view of a first embodiment of loudspeaker apparatus incorporating aspects and features of the present invention;

FIG. 2 shows a sectional view of the loudspeaker apparatus of FIG. 1;

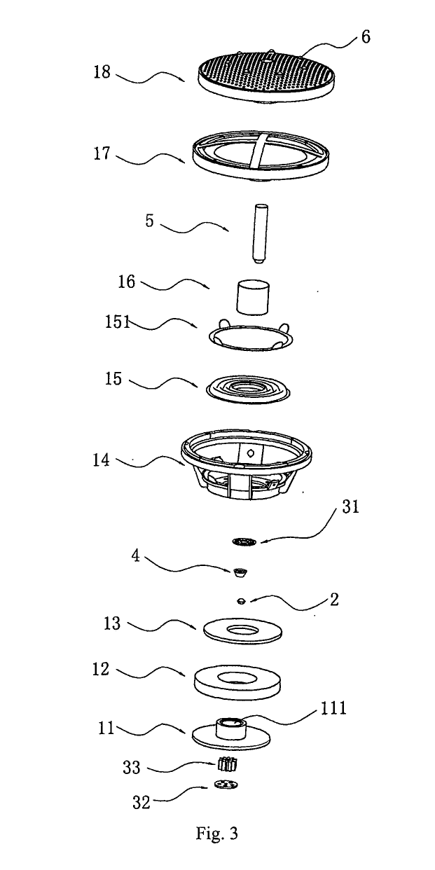

FIG. 3 shows a three-dimensional expanded view of the loudspeaker apparatus of FIG. 1;

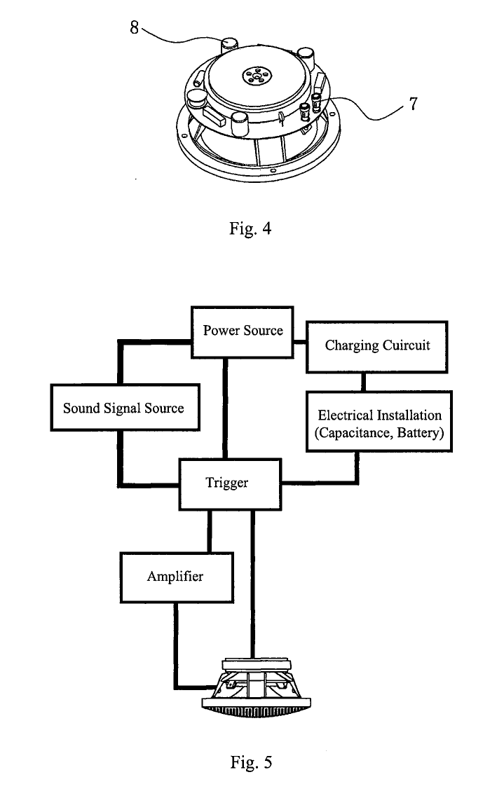

FIG. 4 shows another three-dimensional view of the loudspeaker apparatus of FIG. 1;

FIG. 5 is a representation of an electrical control chart of the loudspeaker apparatus;

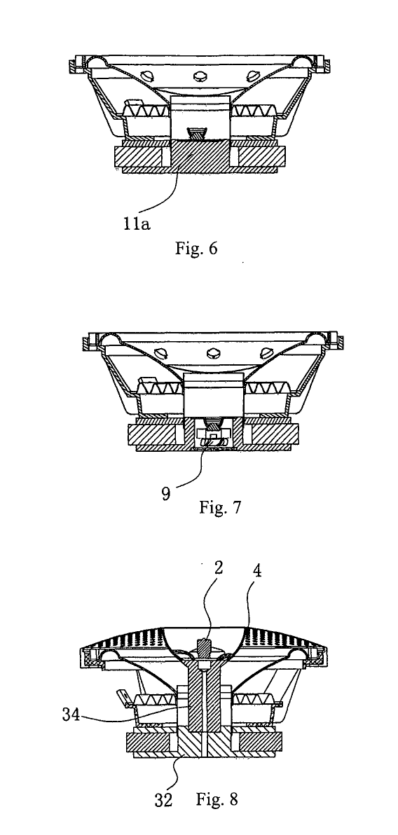

FIG. 6 shows a sectional view of a second embodiment of loudspeaker apparatus incorporating aspects and features of the invention;

FIG. 7 shows a sectional view of a third embodiment of loudspeaker apparatus incorporating aspects and features of the invention;

FIG. 8 shows a sectional view of a fourth embodiment of loudspeaker apparatus incorporating aspects and features of the invention;

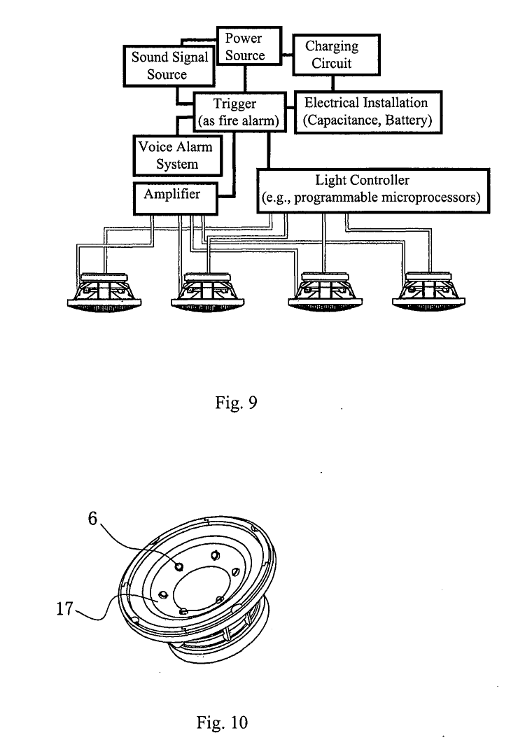

FIG. 9 is a representation of an alarm device control according to a principle of an aspect of the invention;

FIG. 10 is a perspective view showing auxiliary lights installed on the sound cone;

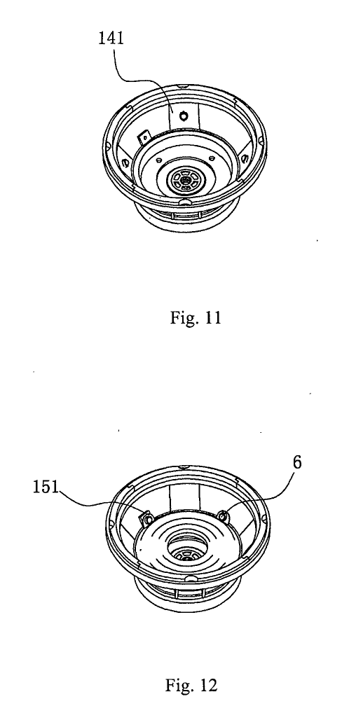

FIG. 11 is a perspective view showing auxiliary lights installed on the speaker frame and reinforcing rib;

FIG. 12 is a perspective view showing auxiliary lights installed on the elastic plate;

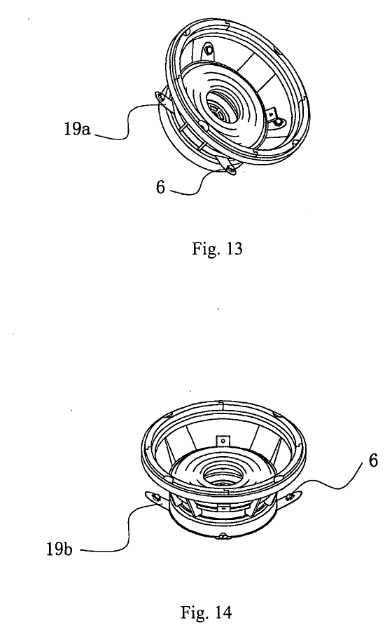

FIG. 13 is a perspective view showing auxiliary lights installed on the first radiation fin between the speaker frame and the up-splint;

FIG. 14 is a perspective view showing auxiliary lights installed on the second radiation fin between the magnet and the T-Yoke;

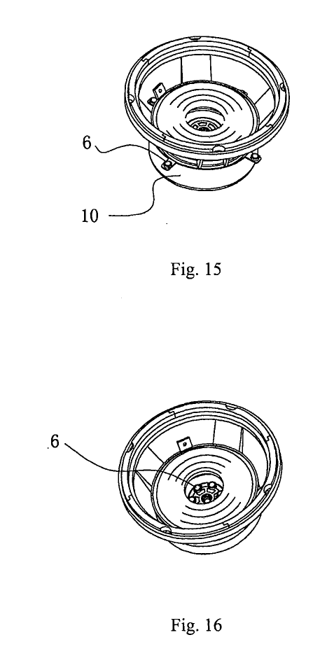

FIG. 15 is a perspective view showing auxiliary lights installed on the magnet cover; and

FIG. 16 is a perspective view showing auxiliary lights mounted around the primary illumination lamp.

### DETAILED DESCRIPTION OF THE PREFERRED EMBODIMENTS

The following is a detailed description of aspects and features of a number of embodiments of loudspeaker apparatus according to the principles of the invention.

In a first embodiment, as shown in FIGS. 1 to 3, a loudspeaker includes a loudspeaker body 1, an illuminating lamp 2, an transparent element, or lens, and a heat radiator, which may also be referred to as a cooling fin or heatsink, 3. The loudspeaker body includes a T-Yoke 11, a magnet 12, a top plate 13, a speaker frame 14, spider 15, a voice coil 16, a speaker cone 17, magnet 12 and top plate 13 back plate of the T-Yoke 11; while said speaker frame 14 mounts on the top plate 13, and speaker cone 17, voice coil 16 and spider 15 conventionally mount in said speaker frame 14.

In this embodiment, the center of T-Yoke 11 has a hole, or bore, formed through its centre as at 111. Illuminating lamp 2 employs a high-power light emitting diode, located in the reflector, or reflector dish, or reflection cup 4. Both illuminating lamp 2 and reflection cup 4 are mounted together within centre-hole or center bore 111 of the T-yoke. The heat sink 3 may also be mounted in the centre-hole or center bore 111. The heat sink may include a front or top or forward perforated plate or cap or bracket with air holes 31, a rear perforated plate or rear cap, or back or bottom bracket 32 with heat dissipation holes, and a radiator element or cooling fin element 33. Front bracket 31, and rear bracket 32 are respectively mounted on top of, (or forward of, or in front of) and below (or rearward of or behind) the openings at either end of centre-hole bore 111. Radiator element 33 is mounted between the rear bracket 32 and illuminating lamp 2. Since the screen or grill 18 is installed on the speaker frame, on the top of the reflector cup, there is a transparent element, which is identified as forward reflector 5, located to transport or transmit the light from the light emitting diode to the front of the load speaker apparatus. The forward reflector has one end (or surface) mounted on the surface of grill 18 and another end (or surface) facing the illuminating lamp 2.

In the event that the external power source is not available, to ensure the loudspeaker and the illuminating lamp can still work normally, the loudspeaker has a built-in emergency power source, namely that of using the general rechargeable batteries 8, as shown in FIG. 4. The electrical control schematic is shown in FIG. 5. The power supply wire of illuminating lamp 2 goes through the heat dissipation hole in rear bracket 32, connecting with trigger switch, while the trigger switch works with rechargeable batteries and general charging circuit connection to terminal 7, at which there is a connection to the external power source.

The external power source is also connected to voice coil 16 of the loudspeaker by means of the trigger switch and a general amplification circuit. Another circuit supplies power for illuminating lamp 2, that power having first been stabilized and rectified. In such normal way, the trigger switch is commonly off. The external power source charges the rechargeable batteries 8 and supplies electricity for the loudspeaker and illuminating lamp.

Light from illuminating lamp 2 is reflected by the reflection cup 4 and refracted by the forward reflector 5, finally light projects out of the top of the forward reflector, to achieve the purpose of illuminating. At the same time, audio signals may be transmitted to voice coil 16, and voice coil 16 causes speaker cone 17 to move, creating vibrations which produce sound.

As this occurs, some air will be caused to move through the rear bracket 32, the forward reflector 33, the illuminating lamp 2, the reflection cup 4, and the bracket 31, so they transfer away the heat given off by the illuminating lamp 2 and the voice coil 16. Apparently, this structure is good for the dissipation of heat of illuminating lamp 2 and voice coil 16, thus to have enough lighting power to provide primary illumination and also to prolong operating life.

If the external power fails, the trigger switch closes, thereby connecting the rechargeable batteries. The rechargeable batteries then supply power to the illuminating lamp and loudspeaker so that they can emit light and sound as normal. Alternatively, the batteries can be a capacitor, or other emergency power such as solar power and bio-electricity, according to different power needs, quality of the loudspeaker and different type of light-emitting diode and amplification circuit.

In regard of different demands for different luminance, auxiliary illuminating lamp (or lamps) 6 may be mounted on other parts of the loudspeaker apparatus, as well as on the front screen or grill. Similarly, movement of the speaker cone may help to transfer heat away from, and therefore cool, the auxiliary illuminating lamp, while the grill itself can function as a heat sink.

In the second embodiment, as shown in FIG. 6, the difference from the first embodiment, above, is that the power of the loudspeaker and illuminating lamp is comparatively small. Therefore the heat they make is not as great. The T-yoke is designed as a solid structure, and acts as a cooling fin or heat radiator, 11a, which means illuminating lamp 2 and reflection cup 4 are mounted on the solid T-yoke, and carry heat away from those elements by conduction in said solid T-yoke, and then external heat transfer from the T-yoke. And the transparent element, which can be a transparent dust cap or speaker cone, gives out light through the transparent areas.

In the third embodiment, as shown in FIG. 7, the difference from the first embodiment is that the power of the loudspeaker and illuminating lamp is comparatively large. Therefore they give out more heat. So fan 9 is mounted between the heat sink and the rear bracket. With the driving of fan 9, the heat can be dissipated rapidly, thus to ensure the normal long-term function of the illuminating element and the loudspeaker.

In the fourth embodiment, as shown in FIG. 8, the difference from the first embodiment is the addition of the mounting post. The illuminating lamp 2 and the reflection cup 4 are stated on the top of the mounting post, the bottom which stands on the T-yoke, to the effect that the edge of reflection 4 and illuminating lamp 2 can be exposed out of the grill 18. So, mounting post 34 and T-yoke make up the cooling fin, or heat sink, or heat radiator. Regarding to the hollow structure of the mounting post, the T-yoke is punched with holes, and through the hollow and holes, heat can dissipate rapidly.

In the fifth embodiment, as shown in FIG. 9 there is an alarm device which includes several loudspeakers, an audio alarm circuit and a programmable controller. As compared to the loudspeaker apparatus of FIG. 5, the fifth embodiment an audio alarm circuit and a programmable controller which connect to the trigger or switch. The controller is operable as a light controller, which may include a programmable microprocessor having its output end connected to drive all of the illuminating lamps of the loudspeaker apparatus. And the trigger can be connected to be responsive to an input signal from an existing fire alarm. When the loudspeaker works normally, the trigger and the light controller are in stand-by mode. In that stand-by mode, the loudspeaker plays and the lights operate in the way shown in FIG. 5.

When there is an emergency, the trigger or switch changes state or moves, and transmits a controlling signal to the light controller. The light controller then operates the lights as strobe lights indicating a path toward an exit, i.e., showing an exit route. Therefore, the loudspeaker provides, or loudspeakers provide, an alarm. The Apparatus not only has the function of providing an alarm and providing guidance to an exit, but also provides emergency light for safe movement. And because every loudspeaker has an emergency power source, it can function without external power. The trigger may also activate an audio signal for fire warning or evacuation of the building.

The scope of protection to which this invention is entitled is not limited to the specific details of the embodiments shown and described above. In the foregoing embodiments the illuminating lamp may also be an halogen lamp or an inert gas lamp; auxiliary illuminating lamp 6 can mount on the frame of the grill; or the auxiliary illuminating lamp can mount on the speaker cone 17, as shown in FIG. 10. The illuminating lamp can employ a silk screen printed circuit to do wiring, or wiring may be provided through a penetration hole in the speaker cone, the lamp then being wired from the back of the speaker cone; a metal speaker cone may advantageously improve heat transfer such as by radiating heat better.

Alternatively, the illuminating lamp may be mounted on the reinforcing rib 141 of the speaker frame, shown as FIG. 11, heat sinked by the metal speaker frame; or mount the illuminating lamp on the adaptor 151 of the spider, shown as FIG. 12, motion of the speaker cone helps to dissipate heat; or mount the illuminating lamp on the first radiation fin 19a between the speaker frame and the top plate, shown as FIG. 13, mass of the first radiation fin and the speaker frame helps to dissipate heat; or mount the said lamp on the second radiation fin 19b between the magnet and T-yoke, shown as FIG. 14, similarly, the motion of the speaker cone helps to radiate; In these example's light is projected through a clear speaker come.

In a further alternative, the lamp may be mounted on the magnetic shield 10 that covers or protects or extends over the T-yoke, shown as FIG. 15, heat transfer therefrom being enhanced by the motion of the speaker cone. In a still further alternative; the auxiliary illuminating lamps may be mounted about or around the illuminating lamp 2, shown as FIG. 16, such structure can reach different levels of luminance, i.e., the brightness of the light being adjustable. In addition, the trigger of the alarm device can be changed by mobile phone link or other link; the volume of loudspeaker, luminance and alarm device can be operated by both wired and wireless way.

1. A loudspeaker with a luminous element, including a magnet (12), a focusing T-yoke (11), a top plate (13) on the magnet, and a speaker frame (14), speaker cone (17), voice coil (16) and spider (15) mounted to the adaptor; a luminous element is held in a reflection cup (4), and is fixed on the T-yoke (11); the luminous element is an illuminating lamp (2), and the illuminating lamp mounts to a heat radiator (3).

2. The loudspeaker with a luminous element of claim 1, wherein the speaker frame has a grill (18); the illuminating lamp and the reflection cup (4) are fixed on the T-Yoke (11) by a radiator tube (34), the edge of the reflection cup (4) and the illuminating lamp (2) on the said grill (18) being exposed, and the radiator tube (34) and T-yoke (11) define the heat radiator (3).

3. The loudspeaker with a luminous element of claim 1, wherein:
said T-yoke (11) has a central bore, in which said illuminating lamp (2) and reflection cup (4) mount;
a transparent element mounts on the illuminating lamp (2);
the heat radiator (2) includes a front bracket with air holes (31), a rear bracket with heat emission holes (32) and a radiator element (33);
the front bracket and the rear bracket are held, respectively, in the top and bottom openings of the central bore (111); and
the radiator element (33) is mounted between the rear bracket (32) and the illuminating lamp (2).

4. The loudspeaker with a luminous element of claim 3, wherein the loudspeaker with a luminous element is includes a fan (9) mounted between said radiating fin and said PCB.

5. The loudspeaker with a luminous element of claim 1, wherein:
the T-yoke is a solid structure;
said illuminating lamp (2), which has a transparent element;
said illuminating lamp is mounted directly to the T-yoke; and
the heat radiator is the solid T-yoke (11a).

6. The loudspeaker with a luminous element of claim 3, wherein:
said speaker frame has a grill (18) mounted thereon;
said transparent element is forward reflector (5), the forward reflector having one end exposed facing outward from the grill (18) and another end facing the illuminating lamp (2).

7. The loudspeaker with a luminous element of claim 3, wherein the transparent element is mounted to a transparent dust cap on the speaker cone (17).

8. The loudspeaker with a luminous element of claim 1, wherein the loudspeaker with a luminous element includes an emergency power source for the illuminating lamp.

9. The loudspeaker with a luminous element of claim 1, wherein the loudspeaker with a luminous element includes an auxiliary illuminating lamp (6), mounted on one of
(a) the speaker cone (17);
(b) a speaker frame rib of the speaker frame;
(c) an adapter ring (151) of the spider;
(d) the first radiation fin (19a) between the speaker frame and a top plate thereof;
(e) the second radiation fin (19b) between the magnet and T-yoke;
(f) the magnetic shield (10) covering the T-yoke back plate;
(g) the grill (18) of the speaker frame; and
(h) said illuminating lamp (2), concentrically therearound.

10. An alarm device including:
a luminous element, a loudspeaker, a sound alarm chip and a programmable controller;
the loudspeaker includes a magnet (12) covering a T-Yoke (11), a top plate on the magnet, and a speaker frame (14), a speaker cone (17), a voice coil (16) and a spider;
the sound alarm chip is connected to the said voice coil (16) by the means of trigger and amplifier circuit of the loudspeaker;
the trigger is connected with the luminous element through the programmable controller;
the alarm device includes several of the loudspeakers, said luminous element is the illuminating lamp (2) in every said loudspeaker, and every illuminating lamp is mounted in a reflection cup (4) of its respective loudspeaker and fixed on the T-yoke (11) on each loudspeaker, and
in each loudspeaker a heat radiator is mounted to the illuminating lamp.
